(19) United States
(12) Patent Application Publication
(10) Pub. No.: US 2016/0189577 A1
(43) Pub. Date: Jun. 30, 2016

(54) ELECTRONIC SHELF LABEL HAVING A MARKING DEFINED BY MEANS OF LASER

(71) Applicant: PRICER AB, Stockholm (SE)

(72) Inventor: Björn NILSSON, Uppsala (SE)

(21) Appl. No.: 14/652,272

(22) PCT Filed: Dec. 11, 2013
(86) PCT No.: PCT/SE2013/051491

§ 371 Date: Jun. 15, 2015

(30) Foreign Application Priority Data
Dec. 21, 2012 (SE) 1251509-4

(51) Int. Cl. G09F 3/20; B41J 3/407; B41J 2/455

(52) U.S. Cl. CPC G09F 3/208; B41J 2/455; B41J 3/4075; G09F 3/204

(57) ABSTRACT

An electronic shelf label (1), ESL, and a method of manufacturing such an ESL is provided. The method comprises providing a transparent cover part (3) for covering a display (6) of the ESL, printing a layer of paint at the cover part, and forming a marking (8) in the layer of paint by means of laser. The present invention is advantageous in that the marking of the ESL is more wear resistant.

### FIELD OF THE INVENTION

The present invention generally relates to the field of electronic shelf labels having markings formed in a cover part of the electronic shelf label by means of laser. The present invention also relates to methods of manufacturing such electronic shelf labels.

### BACKGROUND OF THE INVENTION

An electronic shelf label (conventionally abbreviated ESL) is used for electronically displaying information such as price, label and product name for products and services available for customers. A plurality of ESLs is typically integrated in an ESL system for enabling central control of the information displayed on each ESL. The ESLs communicate with a central control unit of the ESL system making it possible to update and change the information displayed on the ESLs, which saves a considerable amount of time for the persons working in the store, especially if the number of different products in the store is high. As an example, a supermarket normally offers between 50000 and 100000 different products.

For identifying the ESLs in the ESL system, each ESL is assigned an identification code. The identification code is normally adhered to the ESL throughout its lifetime and assigned to the ESL at the manufacturing stage. During manufacturing, the identification code is electronically entered in a memory of the ESL and subsequently, a cover of the ESL is provided with a marking corresponding to the identification code. The marking is normally a sticker with a bar code corresponding to the identification code and enabling reading the identification code of the ESL on-site in the store. A drawback with the sticker is that the sticker in time is deteriorated due to wear and tear and the identification code may eventually get unreadable.

### SUMMARY OF THE INVENTION

Thus, there is a need for providing alternatives that would overcome, or at least alleviate or mitigate the above mentioned drawback. It is with respect to the above considerations that the present invention has been made. An object of the present invention is to provide an improved alternative to the above mentioned technique and prior art.

More specifically, it is an object of the present invention to provide an electronic shelf label having a more wear resistant marking. It is also an object of the present invention to provide a method of manufacturing such an electronic shelf label.

These and other objects of the present invention are achieved by means of an electronic shelf label, a method of manufacturing an electronic shelf label and a production system having the features defined in the independent claims. Preferable embodiments of the invention are defined by the dependent claims.

Hence, according to a first aspect of the present invention, a method of manufacturing an electronic shelf label (ESL) is provided. The method comprises providing a transparent cover part for covering a display of the ESL, printing a layer of paint at the cover part, and forming a marking in the layer of paint by means of laser.

According to a second aspect of the present invention, an ESL is provided. The ESL comprises a transparent cover part for covering a display of the electronic shelf label, and a layer of paint printed at the cover part, wherein a marking is defined in the layer of paint by means of laser.

According to a third aspect of the present invention, a production system is provided. The production system is configured to provide a transparent cover part for covering a display of an electronic shelf label, print a layer of paint at the cover part, and form a marking in the layer of paint by means of laser.

The present invention uses the concept of forming the marking in a layer of paint printed at the cover part (or casing part) by means of laser, which provides a marking of the ESL being more wear resistant than a conventional sticker marking. With the present invention, the marking is integrated in the cover part (and the layer of paint) and may not be peeled off or damaged as easily as a sticker. Hence, reading the marking throughout the lifetime of the ESL is facilitated, as the marking stays more intact in time. Having a marking formed by laser instead of a sticker is also advantageous in that it eliminates the possibility to exchange stickers between different ESLs (e.g. when the ESL is installed in the store), thereby reducing the risk of erroneous identification of the ESL. Further, a marking formed by laser may be cheaper than a sticker marking, whereby manufacturing costs may be reduced.

Forming the marking in the layer of paint is advantageous in that a transparent cover part may be used, as the layer of paint may be adapted to obscure interior components other than a display of the ESL. The cover part may e.g. be moulded in a single piece of transparent plastic, which in a manufacturing point of view is easier and cheaper than moulding a front part comprising both transparent and non-transparent plastic.

Further, the inventors have realized that the above defined method may be utilized for making any kind of marking in the cover part. The marking may e.g. be an identification code (such as a bar code or a serial number), a label, symbol, decorative motive or any other kind of marking desired to apply on the ESL cover. For example, the marking may be formed at the front side of the ESL adapted to face customers when the ESL is mounted to a shelf in a store. The marking may then be accessible (or visible) when the ESL is mounted on the shelf.

According to an embodiment of the invention, forming the marking may comprise removing a portion of the layer of paint by means of laser. Further, the layer of paint may comprise at least one recess defining the marking, which recess may be formed by the removal of the portion of the layer of paint. The removal of material from the layer of paint may be effected by laser burning of the paint. It will be appreciated that the depth of the recess in the paint may be in the range of tenths, hundredths or even thousandths millimetre (i.e. in the range of 10⁻¹ to 10⁻³ mm).

In an embodiment, the portion of the layer of paint is removed such that the layer of paint has a partially transparent portion at the location where the layer of paint is removed. Hence, at least one portion of the layer of paint is partially transparent, which partially transparent portion defines the marking. As the cover part is mounted to the ESL, the interior of the ESL behind the partially transparent portion will be at least partially visible and may act as contrast means in order to make the marking appear darker. Preferably, the paint may have a light color (such as white) to further increase the contrast to the marking. Optionally, contrast means (such as a plate or any piece of material) may be arranged at the inside of the cover part at the marking for making the marking more distinct.

In an embodiment, the method may further comprise printing an additional layer of paint on the layer of paint printed at the cover part such that the additional layer of paint is partially visible through the partially transparent portion. Hence, the ESL may further comprise an additional layer of paint printed on the layer of paint printed at the cover part, the additional layer of paint being partially visible through the partially transparent portion.

The marking may be formed by aiming a laser beam from the side of the cover part without any layer of paint. Hence, the laser beam may propagate through the transparent cover part into the layer of paint printed on the cover part. Alternatively, the laser beam may be aimed at the side of the cover part on which the layer of paint is printed. The additional layer of paint may then be printed (or applied) after the laser operation. In the present embodiment, the additional layer of paint makes the marking appear more distinct. The additional layer of paint may have a color different from the layer of paint printed on the cover part. For example, one of the layers of paint may have a dark color (e.g. black) and the other one a light color (e.g. white). Alternatively, the layers of paint may have similar (or the same) color.

In an embodiment, a second additional layer of paint may be printed on the additional layer of paint (which then may be referred to as a first additional layer of paint). The method may then comprise burning through (or remove material from) both the layer of paint applied directly on the cover part and the first additional layer of paint, whereby the second additional layer of paint may be partly visible through the transparent cover part. Hence, depending on the depth of the laser treatment, different layers of paint will be partly visible from the outside of the cover part (when mounted to the ESL) at the location of the marking. The first and second additional layers may preferably have different colors, thereby enabling a multi color marking.

In the present disclosure, the term “color” is to be widely interpreted and includes any color tone, also white, black and grey. Further, the expression “a color different from another color” is also to be widely interpreted in the present disclosure and includes e.g. colors differing in one or more of the following aspects: hue, colorfulness, shade or tint, or in any other way creating contrast (such as between the marking and the layer of paint) visible for the human eye and/or a scanner for reading the marking.

In an embodiment, removing a portion of the layer of paint by means of laser may leave a burning residue at the location where the layer of paint is removed. Hence, a burning residue from forming the marking by means of laser is disposed at the layer of paint, the burning residue defining the marking. The burning residue from the laser process is utilized to make the marking appear more distinct, in particular if the paint has a light color (such as white or near white). The burning residue may increase the readability of the marking by means of a scanner, such as a bar code scanner.

In an embodiment, the layer of paint may be printed on an inside of the cover part, the inside being adapted to face inwards in the ESL, which is advantageous in that the layer of paint as well as the marking is better protected from wear and tear. Further, the layer of paint comes closer to the display, thereby reducing shadows from the layer of paint at the display. Making the marking by means of laser may be done prior or subsequent to mounting the cover part to the ESL. In the latter case, the marking may be formed by aiming a laser beam from the side of the cover part without any layer of paint (i.e. from the outside when the cover part is mounted to the ESL).

Alternatively, the layer of paint may be applied on the outside of the transparent cover part. The layer of paint may then (optionally) be applied subsequent to mounting the cover part to the ESL. Hence, the cover part may be mated with its ESL before forming the marking, thereby reducing the risk of erroneous identification marking.

In an embodiment, the layer of paint may be printed on the cover part in order to frame the display. Hence, the layer of paint may frame the display. Thus, the layer of paint obscures (or covers) other components of the interior of the ESL. The marking may be formed at any desired location in the layer of paint. For example, a bar code may be formed in the layer of paint at the manufacturing stage of the ESL and the ESL may then be stored for awaiting a purchase order. An additional marking, such as a logotype may be formed in the layer of paint at a later stage, when the ESL is dedicated to a specific purpose (such as a purchase order).

According to an embodiment of the present invention, the layer of paint may comprise pigments adapted to be activated by means of laser, wherein forming the marking comprises activating the pigments by means of laser. Hence, in the ESL, the marking may be defined by such pigments being activated. In the present embodiment, the marking may be defined without removing material from the layer of paint, whereby the layer of paint is smoother compared to the embodiment where the marking is defined by a recess in the layer of paint. Further, the present embodiment is advantageous in that having a layer of paint with pigments is cheaper compared to having the entire cover made in a plastic including such pigments. Non-activated pigments in the layer of paint preferably have (at least nearly) the same color as the layer of paint, thus being less (or not) visible. When the pigments are activated, they turn into a different color, preferably a color different from the color of the layer of paint, thereby defining the marking.

According to an embodiment of the present invention, the marking may correspond to an identification code of the ESL. The identification code of the ESL may be used for identifying the ESL in an ESL system comprising a plurality of ESLs. For example, the identification code may be electronically entered in the ESL, wherein the marking may correspond to the electronically entered identification code. Preferably, the marking may be readable by an identification code scanner. Hence, the marking may be sufficiently distinct (in contrast to the layer of paint) in order to be readable by a scanner or camera. The marking may e.g. be a bar code readable by a bar code scanner. Alternatively, or as a complement, the marking may be a Quick Response (QR) code and/or comprise figures and/or letters corresponding to the identification code.

According to an embodiment, the method may further comprise, in addition to forming the marking in the layer of paint, providing the ESL with an additional marking, preferably on the opposite side of the ESL with respect to the marking in the layer of paint, such as on the backside of the ESL (adapted to face the shelf) if the marking in the layer of paint is located on the front side of the ESL. The additional marking may e.g. comprise the identification code of the ESL and optionally also further information. The additional marking may be formed with a method similar to the method for manufacturing the marking in the layer of paint, hence, by means of laser in a layer of paint. Alternatively, the additional marking may comprise a sticker, an engraving and/or a print.

According to an embodiment, a production system is provided. The production system is configured to provide a transparent cover part for covering a display of an electronic shelf label, print a layer of paint at the cover part, and form a marking in the layer of paint by means of laser. The production system may be configured to perform the method as defined in any one of the preceding embodiments.

Further objectives of, features of, and advantages with, the present invention will become apparent when studying the following detailed disclosure, the drawings and the appended claims. Those skilled in the art realize that different features of the present invention can be combined to create embodiments other than those described in the following. In particular, it will be appreciated that the various embodiments described for the ESL are all combinable with the method as defined in accordance with the second aspect of the present invention.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, in which:

FIG. 1 shows an electronic shelf label according to an embodiment of the present invention;

FIG. 2 is a cross sectional view of a marking in an ESL according to an embodiment of the present invention;

FIG. 3 is a cross sectional view of a marking in an ESL according to another embodiment of the present invention;

FIG. 4 is a cross sectional view of a marking in an ESL according to yet another embodiment of the present invention;

FIG. 5 shows a method of manufacturing an ESL according to an embodiment of the present invention.

All the figures are schematic, not necessarily to scale, and generally only show parts which are necessary in order to elucidate the invention, wherein other parts may be omitted or merely suggested.

### DETAILED DESCRIPTION OF EMBODIMENTS

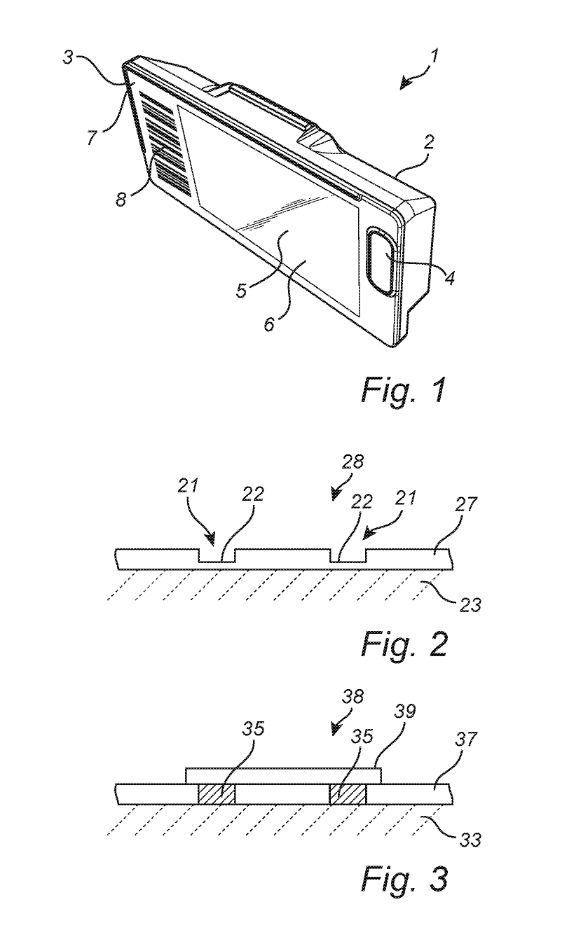

With reference to FIG. 1, an electronic shelf label (ESL) according to an embodiment of the present invention will be described.

The ESL 1 according to the present embodiment may be a part of an ESL system comprising a plurality of ESLs for use in a store. The ESL 1 may be used for displaying information (such as label, price and product information) to customers in the store. The ESLs in the system communicate with a central control unit of the ESL system making it possible to update and change the information displayed on the ESLs.

The ESL 1 comprises a cover (or casing) including a cover part being a front part 3 adapted to face customers and a rear part 2. The rear part 2 may comprise means for mounting the ESL 1 to a shelf or the like (not shown). The ESL 1 comprises a display 6 for displaying product information and the front part 3 comprises a transparent portion 5 covering (and protecting) the display 6. On the front part 3 a layer of paint 7 is printed framing the display 6 and obscuring the interior of the ESL 1. The layer of paint preferably has a light color, such as white or near white. The ESL 1 may further comprise an infrared (IR) sensor and an IR diode for communicating with a transceiver mounted in a ceiling in the store, which in turn communicates with the central control unit of the ESL system. The IR sensor and IR diode are preferably covered by an IR transparent communication window 4 included in the front part 3.

The ESL 1 is provided with an identification code for identifying the ESL 1 in the ESL system. The identification code is e.g. used for centrally updating the information displayed on the ESL 1. The identification code is preferably entered electronically in the ESL 1. The ESL 1 is further provided with a marking 8 comprising a bar code representing the identification code of the ESL 1. The bar code may be readable by a scanner (or bar code reader) and used by store personnel for gathering (and optionally updating) information about the product, and/or linking the ESL to the product. The bar code may also be used by customers for self-scanning of products, in particular products, such as vegetables, not having a package provided with a bar code. However, the marking 8 may alternatively be another kind of marking, such as a label, symbol or a decorative motive. The marking 8 is formed in the front cover part 3 of the ESL 1, thereby being accessible for customers and/or store personnel when the ESL 1 is mounted to a shelf. An additional marking may further be arranged at the rear part of the ESL. Such additional marking may e.g. be similar (or correspond) to the marking 8 in the front part 3 and/or comprise additional information.

In the following, different examples of configurations of the marking of the ESL, as well as method steps for manufacturing such markings will be described with reference to FIGS. 2-4.

With reference to FIG. 2, an example of a marking of the ESL will be described. FIG. 2 is an enlarged view of a cross section of a transparent cover part 23 of the ESL in the area of the marking 28. In the present example, the marking 28 is formed by printing a layer of paint 27 on the transparent cover part 23 and removing, by means of laser, portions of the layer of paint 27, thereby defining recesses 21 in the layer of paint 27. In the recesses 21, the layer of paint is thinner and thereby partially transparent. Hence, partially transparent portions 22 are provided in the layer of paint defining the marking 28. When the cover part 23 is mounted to the ESL, the partially transparent portions will appear dark in contrast to the light colored layer of paint surrounding the marking 28, thereby making the marking visible for a human eye and/or a scanner (such as a bar code reader).

Preferably, the laser operation for removing paint is performed such that a burning residue is provided in the recess (i.e. at the partially transparent portions). The burning residue further improves the contrasts of the marking 28 compared to the surrounding light colored paint.

With reference to FIG. 3, another example of a marking of the ESL will be described. FIG. 3 is an enlarged view of a cross section of a transparent cover part 33 of the ESL in the area of the marking 38. In the present example, a first layer of paint 37 is printed on the transparent cover part 33 and a second layer of paint 39 (also referred to as an additional layer of paint) is applied on the first layer of paint 37. Prior or subsequent to applying the second layer of paint 39, the marking 38 may be defined in the first layer of paint 37 by means of laser. A laser beam may burn (and remove material from) portions 35 the first layer of paint 37, whereby burning residue from the laser operation defines the marking 38. The laser treated portions 35 may be partially transparent, rendering the second layer of paint partially visible through the portions 35. Preferably, the second layer of paint may have a color being darker than the color of the first layer of paint.

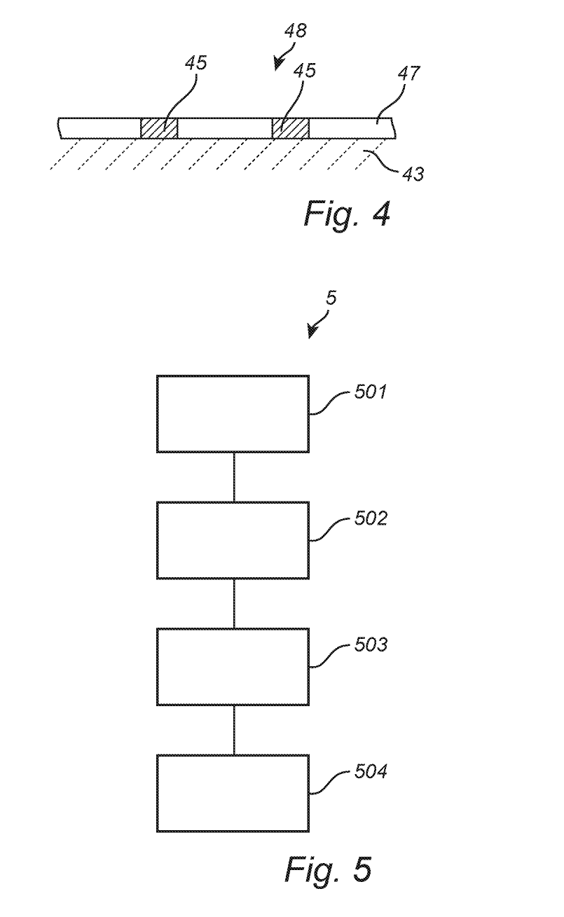

With reference to FIG. 4, yet another example of a marking of the ESL will be described. FIG. 4 is an enlarged view of a cross section of the cover 43 of the ESL in the area of the marking 48. In the present example, the layer of paint 47 comprises pigments which can be activated by means of laser. Non-activated pigments are not visible in the layer of paint, which thereby has its original color. When the pigments are activated, they change color and gets visible in the layer of paint 47. According to the present example, the layer of paint 47 is applied to the cover part 43. Subsequently, portions 45 of the layer of paint 47 are exposed to laser radiation, whereby pigments in the layer of paint 47 are activated at the portions 45, which thereby change color. In the present example, the portions 45 with activated pigments define the marking 48.

In all of the above described embodiments, the layer of paint may be applied either on the inside or on the outside of the cover part, i.e. the sides of the cover part adapted to face inwards and outwards, respectively, when the cover part is mounted to the ESL. Further, the layer of paint may be applied such that it frames the display. Optionally, the layer of paint may comprise sections of different colors of paint.

With reference to FIG. 5, a method 5 of manufacturing an ESL according to an embodiment of the present invention will be described. The method 5 comprises providing 501 a transparent cover part for covering a display of the ESL, and printing 502 a layer of paint at the cover part, preferably such that the layer of paint frames a portion of the cover part adapted to cover the display of the ESL. Prior to (or included in) providing 501 the cover, the method may include moulding the front part of the cover in a single piece of plastic material, preferably transparent plastic.

The method 5 further comprise forming 503 a marking in the layer of paint by means of laser, e.g. by aiming a laser beam at the layer of paint, thereby burning (and optionally removing) portions of the layer of paint, such that a burning residue is left in the layer of paint. Alternatively, or as a complement, forming 503 the marking in the layer of paint may comprise activating pigments included in the layer of paint by means of laser. The laser radiation may be applied from the painted side or the non-painted side of the cover part. Further, the laser radiation may be applied (i.e. the marking may be formed) prior or subsequent to mounting the cover part to the ESL. For example, if the layer of paint is arranged on the inside of the cover part (when the ESL is assembled) the laser radiation may be applied subsequent to mounting the cover part to the ESL and from the outside of the mounted cover part.

Optionally, the method 5 may comprise printing 504 an additional layer of paint (or second layer of paint) at the marking defined in the (first) layer of paint printed at the cover part. The printing 504 of an additional layer of paint may be made prior to or subsequent to forming the marking by means of laser.

While specific embodiments have been described, the skilled person will understand that various modifications and alterations are conceivable within the scope as defined in the appended claims.

1. A method of manufacturing an electronic shelf label, the method comprising:
providing a transparent cover part for covering a display of the electronic shelf label,
printing a layer of paint at the cover part, and
forming a marking in the layer of paint by means of laser.

2. The method as defined in claim 1, wherein forming the marking comprises removing a portion of the layer of paint by means of laser.

3. The method as defined in claim 2, wherein the portion of the layer of paint is removed such that the layer of paint has a partially transparent portion at the location where the layer of paint is removed.

4. The method as defined in claim 3, further comprising printing an additional layer of paint on the layer of paint printed at the cover part such that the additional layer of paint is partially visible through the partially transparent portion.

5. The method as defined in claim 2, wherein removing a portion of the layer of paint by means of laser leaves a burning residue at the location where the layer of paint is removed.

6. The method as defined in claim 1, wherein the layer of paint is printed on an inside of the cover part, the inside being adapted to face inwards in the electronic shelf label.

7. The method as defined in claim 1, wherein the layer of paint is printed on the cover part in order to frame the display.

8. The method as defined in claim 1, wherein the layer of paint comprises pigments adapted to be activated by means of laser, wherein forming the marking comprises activating the pigments by means of laser.

9. The method as defined in claim 1, wherein the marking corresponds to an identification code of the electronic shelf label.

10. The method as defined in claim 1, wherein the marking is readable by an identification code scanner.

11. The method as defined in claim 1, wherein the marking is a bar code readable by a bar code scanner.

12. An electronic shelf label comprising:
a transparent cover part for covering a display of the electronic shelf label, and
a layer of paint printed at the cover part,
wherein a marking is defined in the layer of paint by means of laser.

13. The electronic shelf label as defined in claim 12, wherein the layer of paint comprises at least one recess defining the marking.

14. The electronic shelf label as defined in claim 12, wherein at least one portion of the layer of paint is partially transparent, which partially transparent portion defines the marking.

15. The electronic shelf label as defined in claim 14, further comprising an additional layer of paint printed on the layer of paint printed at the cover part, the additional layer of paint being partially visible through the partially transparent portion.

16. The electronic shelf label as defined in claim 12, wherein a burning residue from forming the marking by means of laser is disposed at the layer of paint, the burning residue defining the marking.

17. The electronic shelf label as defined in claim 12, wherein the layer of paint is printed on an inside of the cover part facing inwards in the electronic shelf label.

18. The electronic shelf label as defined in claim 12, wherein the layer of paint frames the display.

19. The electronic shelf label as defined in claim 12, wherein the layer of paint comprises pigments adapted to be activated by means of laser and the marking is defined by such pigments being activated.

20. The electronic shelf label as defined in claim 12, wherein the marking corresponds to an identification code of the electronic shelf label.

21. The electronic shelf label as defined in claim 20, wherein the marking is readable by an identification code scanner.

22. The electronic shelf label as defined in claim 20, wherein the marking is a bar code readable by a bar code scanner.

23. A production system configured to:
provide a transparent cover part for covering a display of an electronic shelf label,
print a layer of paint at the cover part, and
form a marking in the layer of paint by means of laser.
